(19) United States
(12) Patent Application Publication
(10) Pub. No.: US 2011/0203928 A1
(43) Pub. Date: Aug. 25, 2011

(54) SILICA REMEDIATION IN WATER

(75) Inventors: Danielle Lynn Petko, Schenectady, NY (US); Larry Neil Lewis, Scotia, NY (US); Donald Wayne Whisenhunt, JR., Niskayuna, NY (US); Ming Yin, Rexford, NY (US); Andrea Jeannine Peters, Clifton Park, NY (US); Robert Edgar Colborn, Niskayuna, NY (US)

(73) Assignee: GENERAL ELECTRIC COMPANY, Schenectady, NY (US)

(21) Appl. No.: 12/712,225

(22) Filed: Feb. 25, 2010

(51) Int. Cl. B01D 57/02; C02F 1/52; B01D 59/42

(52) U.S. Cl. 204/536; 210/714

(57) ABSTRACT

Water treatment methods for reducing silica concentration in water containing at least 100 ppm dissolved or suspended silica include contacting the water with particles comprising mesoporous alumina having surface area ranging from about 250 m2/g to about 600 m²/g and pore volume ranging from about 0.1 cm³/g to about 1.0 cm³/g; and separating the treated water from the particles.

### STATEMENT REGARDING FEDERALLY SPONSORED RESEARCH AND DEVELOPMENT

This invention was made with Government support under contract number DE-NT0005961 awarded by the U.S. Department of Energy. The Government has certain rights in the invention.

### BACKGROUND

Demand for freshwater is steadily increasing throughout the United States. As population increases, and more water is needed for domestic use, power generation and agricultural use, existing freshwater supplies will not able to meet demand. Especially in arid regions, new water users are often forced to look to alternative sources of water to meet their needs. Even in areas that are not traditionally water-poor, including East Coast states of Georgia, Maryland, Massachusetts, New York, and North Carolina, some utilities have had to reassess the availability of water to meet cooling needs.

To reduce withdrawal and consumption of high-quality freshwater for power production, cost-effective approaches to using non-traditional, impaired or alternative sources of water will be needed to supplement or replace freshwater for cooling and other power plant needs. Examples of non-traditional waters include surface and underground mine pool water, coal-bed methane produced waters, and industrial and/or municipal wastewater.

Using effective treatment methods to make non-traditional water sources available to power-plant water needs will allow power plants that are affected by water shortages to continue to operate at full capacity without adversely affecting local communities or the environment by limiting freshwater withdrawals.

Silica is present in many impaired waters, especially in the southwest United States (Brady, P. V., Kottenstette, R. J., Mayer, T. M., Hightower, M. M.; J. Contemporary Water Res & Ed., 2005, 132, 46-51). It can often be the limiting factor for cooling tower applications. An incoming water stream containing 100 ppm silica is typically cycled only two or three times before silica scale starts to form, dramatically reducing the efficiency of the cooling tower. Silica scales are very difficult to remove once formed so cooling tower operators are generally very conservative with respect to silica.

The concentration of silica in impaired water for use in cooling tower applications is desirably below 20 ppm, ideally closer to 10 ppm. Technology to reduce silica levels by 90% (from 100 ppm to 10 ppm) would enable a 50% reduction in the withdrawal of fresh water for the cooling tower. Accordingly, there is a need for methods to treat water, especially impaired waters, in order to reduce/minimize high-quality freshwater withdrawal and consumption.

### BRIEF DESCRIPTION

In one aspect, the present invention relates to water treatment methods for reducing silica concentration in water containing at least 100 ppm dissolved or suspended silica. The methods include contacting the water with particles comprising mesoporous alumina having BET surface area ranging from about 250 m²/g to about 600 m²/g and pore volume ranging from about 0.1 cm³/g to about 1.0 cm³/g; and separating the treated water from the particles.

### DETAILED DESCRIPTION

Water treatment methods according to the present invention are effective in reducing silica concentration in water containing at least 100 ppm dissolved or suspended silica; silica levels may be reduced to less than about 10 ppm. In many embodiments, the methods are effective in reducing silica concentration in water containing less than 100 ppm dissolved or suspended silica. Water to be treated may contain other dissolved or suspended materials, including multivalent cations present in hard water such as calcium and magnesium ions. The multivalent cations may be removed by electrodialysis reversal, either before or after the silica is removed, although it may be advantageous to soften the water before silica removal. Electrodialysis reversal (EDR) is an electrically driven membrane process for removing dissolved salts from moderately hard water (total dissolved solids (TDS) ˜4000 ppm). It is a commercial self-cleaning and chlorine tolerant technology. Impaired waters may be treated by the methods of the present invention. Waters for which an applicable water quality standard has not been met, even after required minimum levels of pollution control technology have been adopted. Such waters are considered “water quality-limited” or impaired waters by the United States Environmental Protection Agency (EPA). Sources of impaired water include treated municipal wastewater, stormwater runoff, and irrigation return flow. Such waters may contain biological solids.

Mesoporous aluminas suitable for use in the methods of the present invention have BET surface area ranging from about 250 m²/g to about 600 m²/g and pore volume ranging from about 0.1 cm³/g to about 1.0 cm³/g. BET surface area is surface area of the particles as determined by a BET surface area method. The BET method is widely used in surface science for the calculation of surface areas of solids by physical adsorption of gas molecules, and is well known in the art. In particular embodiments, surface area of the mesoporous alumina ranges from about 300 m²/g to about 450 m²/g, and/or pore volume of the mesoporous alumina ranges from about 0.25 cm³/g to about 0.75 cm³/g. In other embodiments, pore volume of the mesoporous alumina ranges from about 0.4 cm³/g to about 0.6 cm³/g. The mesoporous aluminas typically have periodically arranged pores of average diameter ranging from about 2 nm to about 100 nm, preferably from about 2 nm to about 50 nm, with periodicity ranging from about 50 Å to about 130 Å. Particle size of the mesoporous alumina may be less than about 100 micrometers, and in particular embodiments, ranges from about 1 micrometer to about 10 micrometers. Pore diameter typically ranges from about 2 nm to about 100 nm, particularly from about 2 nm to about 20 nm, and more particularly from about 2 nm to about 10 nm. Periodicity ranges from about 50 Å to about 150 Å, particularly from about 50 Å to about 100 Å. Pore size typically has a narrow monomodal distribution, particularly having a pore size distribution polydispersity index of less than 1.5, particularly less than 1.3, and more particularly less than 1.1. The distribution of diameter sizes may be bimodal, or multimodal.

Mesoporous aluminas for use in the methods of the present invention may be prepared by reacting an aluminum alkoxide in the presence of a templating agent. WO 2009/134558 and WO 2009/038855 describe processes that may be suitable for preparing the mesoporous aluminas, and are incorporated herein by reference in their entirety. Suitable templating agents include, but are not limited to, non-ionic surfactants, cyclodextrins, and crown ethers. Particularly suitable templating agents are polyethylene glycol surfactants, particularly polyethylene glycol phenyl ethers, and especially polyethylene glycol tert-octylphenyl ether, commercially available as TRITON X-114®. A modifying agent such as ethyl acetoacetonate may also be present during the reaction. A particularly suitable aluminum alkoxide is aluminum sec-butoxide.

The mesoporous aluminas may contain up to about 10% molybdenum, based on the total weight of the mesoporous alumina. The molybdenum may be present in an amount ranging from about 0.05 weight percent to about 10 weight percent, particularly from about 0.1 weight percent to about 5 weight percent, and more particularly from about 0.1 weight percent to about 2 weight percent. In some embodiments, the amount of molybdenum is less than 0.1 weight percent.

The molybdenum-containing mesoporous alumina may be prepared by including a molybdenum compounding the reaction mixture when reacting the aluminum alkoxide. In particular, bis(acetylacetonato)dioxomolybdenum) or ammonium molybdate may be used.

The water treatment methods of the present invention include contacting the water with particles comprising the mesoporous alumina materials described above and separating the treated water from the particles. Treatment may be performed at a neutral pH, that is pH of the water ranges from about 5 to about 8. Temperature at which the water may be treated ranges from about 5° C. to about 100° C. In a particular embodiment, wherein the water is passed through a column containing the particles.

In some embodiments, the methods additionally include subjecting the water to an electro-dialysis reversal process, before or after treatment with the mesoporous alumina.

### EXAMPLES

The following examples illustrate methods and embodiments in accordance with exemplary embodiments, and as such should not be construed as imposing limitations upon the claims.

### General Procedures

### Preparation of 100 ppm Silica Water

100 ppm silica water is prepared as follows. A 4 L plastic beaker is tared on a balance. 3 L (3000 g) of DI H₂O is then added to the beaker. 100 ppm sodium silicate as silica is weighed out in a weigh boat (for 4 L, 1.413 g sodium silicate pentahydrate). While stirring, the weighed silica is added to the 3000 g of DIH₂O. The pH of the solution is taken while stirring, and 1.0N HCl is used to bring the pH close to 7.0 (7.2-7.3). Upon reaching pH 7.2-7.3, 0.1N HCl is added to the solution until pH 7.0 is reached. After the solution is adjusted to pH 7.0, DIH₂O is added to approximately 3900 g (3.9 L). The pH of the solution is then retaken and adjusted if necessary to 7.0. The silica solution is then topped off to 4000 g (4 L).

Preparation of 50 ppm Silica Make-Up Water with Hardness

Two solutions are used to prepare 50 ppm silica make-up water. The first, Make-Up A, is prepared by combining 199.6 mg anhydrous calcium chloride (CaCl₂) and 144.3 mg anhydrous magnesium sulfate (MgSO₄) in a 500 mL volumetric flask. The flask is filled to the line with deionized water. Make-Up B is prepared by combining 176.6 mg sodium metasilicate pentahydrate (Na₂SiO₃.5H₂O), 55.4 mg sodium bicarbonate, and 166 μL 10 N sulfuric acid (H₂SO₄) in a 500 mL volumetric flask, which is filled to the line with deionized water. Make-Up A and B are combined in equal amounts prior to use.

Preparation of 100 ppm Silica Make-Up Water with Hardness

Two solutions are used to prepare 100 ppm silica make-up water. The first, Make-Up A, is prepared by combining 199.6 mg anhydrous calcium chloride (CaCl₂) and 144.3 mg anhydrous magnesium sulfate (MgSO₄) in a 500 mL volumetric flask. The flask is filled to the line with deionized water. Make-Up B is prepared by combining 353.1 mg sodium metasilicate pentahydrate (Na₂SiO₃.5H₂O), 55.4 mg sodium bicarbonate, and 333 μL 10 N sulfuric acid (H₂SO₄) in a 500 mL volumetric flask, which is filled to the line with deionized water. Make-Up A and B are combined in equal amounts prior to use.

### Bottle Test

Bottle tests are performed by weighing out a predetermined amount of adsorbent into a 125 mL Nalgene bottle, 15 dram plastic vial, 7 dram plastic vial, or 12 mL plastic test tube depending on scale. A magnetic stir bar and either 125 mL, 45 mL, 20 mL, or 12 mL of the make-up water is added to the bottle, vial, or test tube. The mixture is stirred for 5 minutes to 24 hours (in a standard test, stir for 30 minutes). The adsorbent is then filtered off using a 0.02 μm syringe filter (in a standard test) or Whatman 50 filter paper. Silica content can be determined using the silicomolybdate colorimetric method.

### Loading and Regeneration of Alumina

To test the regeneration of alumina, the alumina is first loaded to capacity with silica. Loading is accomplished by stirring 3.5 g of alumina in 1 L of 100 ppm silica water for 24 hours. The alumina is then filtered from the water using Whatman 50 filter paper. The silica content of the water is then measured using the silicomolybdate colorimetric method. This process is repeated with the same alumina and fresh 100 ppm silica water until the alumina is only removing 50% or less of the silica in the water. The alumina is then dried and ready for regeneration.

The alumina is regenerated by adding 1.0 g of the loaded alumina to 100 mL of caustic (10% NaOH). The mixture is stirred for 30 minutes and then the alumina is filtered off using Whatman 50 filter paper and washed with an excess of deionized water. The efficiency of the regeneration is tested by performing a bottle test (see procedure above) with the regenerated alumina versus the loaded alumina.

### Column Studies

Alumina (2 g) was added to a stainless steel column. Silica water (100 ppm) with hardness was run through the column downflow at a rate of 60 mL/hour. A fraction collector was used to collect samples continuously, every 10 minutes. Samples were tested for silica concentration using the automated silicomolybdate method.

In-column regeneration was attempted by running 250 mL 10% NaOH through the column at a rate of 60 mL per hour. The column was then flushed with water to neutralize the column.

### Silicomolybdate Test Procedure for Determination of Silica Content

Silica content is determined via a colorimetric method using a molybdate reagent comprised of 4.84 g sodium molybdate, 13.86 mL concentrated nitric acid, and 1.72 g sodium dodecyl sulfate in deionized water (total volume=1 L). 1 mL of reagent is added to 0.5 mL of sample and is allowed to sit for 5 minutes prior to taking the UV measurement. The absorbance is recorded at 410 nm.

High throughput Method for Determination of Dissolved Silica

High throughput determination of dissolved silica concentration employs an overall volume of only 250-300 uL. Multiple standards and blanks are placed in a flat-bottomed, optically clear, polystyrene, 96-well plate and the absorbances of the samples at 410 nm are measured every 90 seconds over a period of 40 minutes using a commercial multi-well plate reader (Molecular Devices SpectraMax M5). The kinetic plots for the standard samples show that after about 18 minutes of reaction time the absorbance values of the samples with 80 ppm silica or less are stable and remain so up to at least 40 minutes. The calibration curves obtained at various time points covering the range of 0 to 80 ppm silica are equivalent after 18 minutes of reaction time. FIG. 2 shows the calibration curve after 22.5 minutes.

### Example 1A

### Preparation of Mesoporous Alumina (GRC MPA)

A 12 L 3-neck flask equipped with a mechanical stirrer and water-cooled condenser was charged with ethylacetoacetate (26.43 g, 0.203 mol), Triton X-114 (136.76 g) and IPA (600 mL). Aluminum sec-butoxide (501.39 g, 2.04 mol) was combined with 2 L IPA and added to the stirring flask. After 30 min, a solution of water (74 mL, 4.11 mol) and IPA (1 L) was added at a rate of 8 mL/min. The contents were then heated at reflux for 24 h. 581.2 g of the slurry were kept for later spray-drying. The remainder was filtered and then the solid extracted in a soxhlet extractor with ethanol and then the solid was dried in a vacuum oven at 100° C. under reduced pressure for 24 h. The solid was then pyrolyzed under nitrogen at 550° C. and then calcined in air at 550° C.

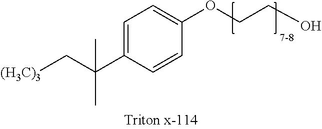

### Example 1B

### Preparation of Molybdenum-Containing Mesoporous Alumina (GRC MPA Mo-acac)

A 1 L 3-neck flask equipped with a mechanical stirrer and water-cooled condenser was charged with ethylacetoacetate (2.65, 0.02 mol), Triton X-114 (14 g) and IPA (60 mL). Aluminum sec-butoxide (50 g, 0.2 mol) was combined with 200 mL IPA and bis(acetylacetonato)dioxomolybdenum) (1.63 g (0.005 mole) were added to the stirring flask. After 30 min, a solution of water (7.5 mL), and IPA (85 mL) was added at a rate of 0.6 mL/min. The contents were then heated at reflux for 24 h and was filtered and then the solid extracted in a soxhlet extractor with ethanol and then the solid was dried in a vacuum oven at 100° C. under reduced pressure for 24 h. The solid was then pyrolyzed under nitrogen at 550° C. and then calcined in air at 550° C.

### Example 10

### Preparation of Molybdenum-Containing Mesoporous Alumina (GRC MPA Ammonium Molybdate)

A 1 L 3-neck flask equipped with a mechanical stirrer and water-cooled condenser was charged with ethylacetoacetate (2.65 g, 0.02 mol), Triton X-114 (14 g) and IPA (60 mL). Aluminum sec-butoxide (50 g, 0.2 mol) was combined with 200 mL IPA was added to the stirring flask. After 30 min, (0.883 g (0.714 mmole) Ammonium molybdate tetrahydrate was dissolved in 75 mL water and mixed with 85 mL IPA, the mixture was added at a rate of 0.6 mL/min. The contents were then heated at reflux for 24 h and was filtered and then the solid extracted in a soxhlet extractor with ethanol and then the solid was dried in a vacuum oven at 100° C., −30 in. Hg for 24 h. The solid was then pyrolyzed under nitrogen at 550° C. and then calcined in air at 550° C.

### Example 1D

### Properties of Mesoporous Alumina

| | | | GRC MPA - | GRC MPA - |
|---|---|---|---|---|
| | | GRC MPA - | Ammonium | Ammonium |
| | GRC-MPA | Mo-acac | Molybdate | Molybdate 2 |
| BET Surface | 418 | 544 | 401 | 532 |
| Area, m²/g | | | | |
| Pore | 558 | 642 | 529 | 632 |
| Volumn** | | | | |
| (m³/g) | | | | |
| Pore width | 5.6 | 3.4 | 7.0 | 6.7 |
| (nm) | | | | |
| % by weight | | 4.295% | 0.270% | 4.045% |
| Mo: | | | | |

Notes:
BET measurements were done using MIRCROMERITICS ® ASAP 2020 Accelerated Surface Area and Porosimetry System
Pore volume is BJH Adsorption cumulative volume of pores between 1.7000 nm and 300.0000 nm diameter
Pore width is Adsorption average pore width (4V/A by BET)

### Example 2

### Establishing Baseline Performance

Materials tested are shown in Table 1.

TABLE 1

| Supplier | Name | Size | | Surface Area | |
|---|---|---|---|---|---|
| Fisher | Alumina, Basic, Brockman Activity I | 60-325 | mesh | 143 | m2/g |
| Sigma-Aldrich | Aluminum Oxide, Activated, Neutral, | 150 | mesh | 155 | m2/g |
| | Brockman Activity I | | | | |
| Sigma-Aldrich | Aluminum Oxide, Activated, Basic, | 150 | mesh | 155 | m2/g |
| | Brockman Activity I | | | | |
| Fisher | Aluminum Oxide, Anhydrous | | | <1 | m2/g |
| Sasol | Catalox Sba Fine Alumina | 45 | um | 90-210 | m2/g |
| Sigma-Aldrich | Aluminum Oxide, Nanopowder | <50 | nm | 40 | m2/g |
| Cabot | SpectrAl 100 | <50 | nm | 95 | m2/g |
| Corporation | | | | | |
| Denka | DAW-45 - Aluminum Oxide | 45 | um | 0.2 | m2/g |
| Denka | DAW-70 - Aluminum Oxide | 70 | um | 0.1 | m2/g |
| Denka | DAW-05 - Aluminum Oxide | 5 | um | 0.5 | m2/g |
| Cabot | SpectrAl 81 | <50 | nm | 80 | m2/g |
| Corporation | | | | | |
| Cabot | SpectrAl 51 | <50 | nm | 55 | m2/g |
| Corporation | | | | | |
| Sasol | Catapal B Dispersible Alumina | 60 | um | 250 | m2/g |
| | (Boehmite) | | | | |
| Sasol | Dispal 23N4-80 Dispersible Alumina | 50 | um | 200 | m2/g |
| | (Boehmite) | | | | |
| Denka | DAW-03 - Aluminum Oxide | 3 | um | 0.7 | m2/g |
| Denka | ASFP-20 - Aluminum Oxide | 0.2-0.5 | um | 12-18 | m2/g |
| Sigma-Aldrich | Aluminum Oxide, Mesoporous, MSU-X | 5.65 | um | 364 | m2/g |
| | type | | | | |
| Dow (Union | Linde B Alumina | 50 | nm | 75-90 | m2/g |
| Carbide) | | | | | |
| GRC MPA | Mesoporous Alumina | <100 | um | 400 | m2/g |

Bottle tests were used to determine the thermodynamic capacity for silica of various alumina materials. The data shows that higher surface area correlated to greater % Si uptake (see Tables 2 and 3).

TABLE 2

| Material | % Removal |
|---|---|
| Cabot SpectrAl 100 | 74.7% |
| Cabot SpectrAl 51 | 54.2% |
| Cabot SpectrAl 81 | 70.9% |
| Denka ASFP-20 - Aluminum Oxide | 21.5% |
| Denka DAW-03 - Aluminum Oxide | 3.8% |
| Denka DAW-05 - Aluminum Oxide | 1.1% |
| Denka DAW-45 - Aluminum Oxide | 0.7% |
| Denka DAW-70 - Aluminum Oxide | 1.3% |
| Fisher Alumina, Basic | 95.9% |
| Fisher Aluminum Oxide, Anhydrous | 3.2% |
| GRC Mesoporous Alumina | 99.1% |
| Linde B Alumina | 68.3% |
| Sasol Catalox Sba Fine Alumina | 95.1% |
| Sasol Catapal B Dispersible Alumina (Boehmite) | 82.4% |
| Sasol Dispal 23N4-80 Dispersible Alumina (Boehmite) | 26.3% |
| Sigma-Aldrich Aluminum Oxide, Activated, Basic | 95.6% |
| Sigma-Aldrich Aluminum Oxide, Activated, Neutral | 93.7% |
| Sigma-Aldrich Aluminum Oxide, Mesoporous, MSU-X | 98.4% |
| type | |
| Sigma-Aldrich Aluminum Oxide, Nanopowder | 37.7% |

TABLE 3

| | % Silica Removal | | | |
|---|---|---|---|---|
| Name | 0.016 g/mL | 0.012 g/mL | 0.008 g/mL | 0.004 g/mL |
| Fisher Alumina, Basic | 95.9% | 91.4% | 80.8% | 43.4% |
| Sigma-Aldrich Aluminum Oxide, | 93.7% | 64.3% | 89.3% | 66.4% |
| Activated, Neutral | | | | |
| Sigma-Aldrich Aluminum Oxide, | 95.6% | 88.9% | 78.4% | 65.7% |
| Activated, Basic | | | | |
| Sasol Catalox Sba Fine Alumina | 95.1% | 90.6% | 84.5% | 66.5% |
| Cabot SpectrAl 100 | 74.7% | 68.6% | 57.0% | 29.4% |
| Sasol Catapal B Dispersible | 82.4% | 80.5% | 70.1% | 42.2% |
| Alumina (Boehmite) | | | | |
| Sigma-Aldrich Aluminum Oxide, | 98.4% | 95.9% | 89.5% | 70.4% |
| Mesoporous, MSU-X type | | | | |
| GRC Mesoporous Alumina (GRC | 99.1% | 97.8% | 93.1% | 74.3% |
| MPA) | | | | |

The results shown in Tables 2 and 3 were obtained after 30 minutes. To understand the kinetics of uptake a couple of the better performing alumina materials were sampled at different time points. The results for these materials are shown in Table 4.

Silica uptake was measured as a function of time for two commercial alumina materials (Sigma MPA and Fisher Alumina) and 3 GRC MPA alumina materials. The GRC-MPA Ig ps was a larger particle size (400-700 um) version of the same material as GRC MPA (sm ps) (<100 um) which had much faster kinetics. The GRC-MPA (sm ps 2× amount) is the same material and particle size as GRC-MPA (sm ps) but at twice the adsorbent loading.

TABLE 4
% Silica Removal

| | | | | GRC | | | |
|---|---|---|---|---|---|---|---|
| | | | | MPA | Sigma | | |
| | | GRC | GRC | sm ps | Alu- | Sasol | Fisher |
| Time | Sigma | MPA | MPA | 2x | mina, | Catalox | Alu- |
| (min) | MPA | Lg ps | sm ps | amount | Basic | Sba | mina |
| 5 | 68.3% | 46.5% | 83.8% | 95.3% | 48.1% | 56.0% | 53.7% |
| 15 | 82.1% | 74.8% | 94.1% | 98.4% | 66.4% | 68.7% | 69.5% |
| 30 | 89.5% | 93.1% | 96.7% | 99.8% | 79.4% | 79.5% | 84.8% |

### Example 3

### Uptake of Calcium and Magnesium in 50 ppm Silica Water with Hardness

Studies were done to determine the effect of hardness on silica uptake in bottle tests. GRC-MPA was compared to a standard activated alumina, as well as a commercially available mesoporous alumina. Silicomolybdate analysis was used; 0.36 g of adsorbent was used for every 45 mL of 50 ppm silica water with hardness for the first three data sets. Results of the test are shown in Table 5. The results indicate that the GRC-MPA has some degree of selectivity toward silica uptake when compared to that of calcium and magnesium. This is in contrast to the commercially available activated alumina, which took up less silica and more magnesium than GRC-MPA.

TABLE 5
Hard Water - 50 ppm Silica

| | | | | |
|---|---|---|---|---|
| | 00Sigma | GRC MPA - | Fisher | GRC MPA - <100 |
| Time (min) | MPA | <100 um | Alumina | um - 2x amount |

% Silica Removal

| | | | | |
|---|---|---|---|---|
| 5 | 79.6% | 90.6% | 56.5% | 97.4% |
| 15 | 90.8% | 96.1% | 79.9% | 100.0% |
| 30 | 94.6% | 98.4% | 85.0% | 100.0% |

Calcium Removal

| | | | | |
|---|---|---|---|---|
| 5 | 11.3% | 20.3% | 20.5% | 35.2% |
| 15 | 11.6% | 22.8% | 21.2% | 38.6% |
| 30 | 12.2% | 23.2% | 21.3% | 40.3% |

Mg Removal

| | | | | |
|---|---|---|---|---|
| 5 | 6.2% | 12.9% | 23.0% | 23.0% |
| 15 | 6.4% | 13.9% | 26.0% | 24.8% |
| 30 | 7.0% | 14.4% | 26.0% | 25.6% |

### Example 4

### Capacity Tests—Comparison of GRC-MPA to Commercially Available Activated Aluminas

Several capacity tests were performed to compare the GRC-MPA to standard, commercially available activated alumina. Bottle tests were done on both a 30 minute and 24 hour time scale. The results for the 30-minute and 24-hour capacity tests for GRC-MPA are shown in FIGS. 10 and 11 respectively. The measured capacity from the 30-minute test was 18.61 mg/g, whereas the measured capacity from the 24-hour test was 36.25 mg/g. This indicates that the GRC-MPA can adsorb more silica after the 30-minute timepoint. The results for the 30-minute and 24-hour capacity tests for Sigma basic activated alumina are shown in FIGS. 12 and 13 respectively. The measured capacity for 30-minute test was 7.64 mg/g, whereas the measured capacity from the 24-hour test was 32.06 mg/g. While the GRC-MPA is better in both cases, it picks up more than double the amount of silica in the 30-minute capacity test than the commercially available activated alumina, confirming our previous findings that the GRC-MPA is better than commercially available aluminas, especially for the shorter time points.

TABLE 6

| g | | | | | |
|---|---|---|---|---|---|
| sorbent | Cₚₚₘ | % silica removed | g sorbent | Cₚₚₘ | % silica removed |
| GRC MPA, 30 minute | | | GRC MPA, 24 hour | | |
| 0 | 98.7 | 0.00% | 0 | 71.8 | 0.00% |
| 0.18 | 16.6 | 83.13% | 0.045576 | 31.5 | 56.13% |
| 0.36 | 5 | 94.93% | 0.09 | 12.8 | 82.17% |
| 0.54 | 2.4 | 97.57% | 0.1861 | 0.7 | 99.03% |
| 0.72 | 1.1 | 98.89% | 0.3718 | 0.3 | 99.58% |
| 0.9 | 0.6 | 99.39% | 0.5588 | 0 | 100.00% |
| 1.08 | 0.1 | 99.90% | 0.7193 | 0 | 100.00% |
| 1.26 | 0 | 100.00% | 0.9029 | 0 | 100.00% |
| 1.44 | 0 | 100.00% | | | |
| basic activated | | | basic activated | | |
| alumina, 30 minute | | | alumina, 24 hour | | |
| 0 | 77.3 | 0.00% | 0 | 112.6 | 0.00% |
| 0.1799 | 39.2 | 49.29% | 0.05004 | 60.1 | 46.63% |
| 0.3635 | 18.8 | 75.68% | 0.09648 | 38.6 | 65.72% |
| 0.5486 | 9.8 | 87.32% | 0.13824 | 20.4 | 81.88% |
| 0.736 | 4.9 | 93.66% | 0.198 | 6.7 | 94.05% |
| 0.8996 | 2.7 | 96.51% | 0.369 | 1.5 | 98.67% |
| 1.0827 | 1.6 | 97.93% | 0.548 | 0 | 100.00% |
| 1.293 | 0.1 | 99.87% | 0.731 | 0 | 100.00% |
| 1.466 | 0 | 100.00% | 0.901 | 0 | 100.00% |
| | | | 1.093 | 0 | 100.00% |
| | | | 1.268 | 0 | 100.00% |
| | | | 1.453 | 0 | 100.00% |

### Example 5

### Regeneration

Regenerated GRC-MPA demonstrated 61.0% silica removal in a small-scale bottle test as compared to unregenerated, silica loaded GRC-MPA, which demonstrated 18.2% removal in a bottle test. The same amount of fresh GRC-MPA achieved approximately 71.3% removal.

In-column regeneration is accomplished using lower pH than that used for bottle studies to prevent alumina dissolution that may cause plugging of the column.

### Example 6

### Column Studies

Both GRC alumina and activated basic alumina were tested using a procedure where the silica solution is passed down-flow through the column instead of up-flow. The down-flow configuration simulates field use using a stainless steel column with higher pressure pumps.

As a baseline, commercial activated basic alumina (Sigma-Aldrich) was tested for its ability to remove silica using a column configuration (down-flow) using 100 ppm silica water with hardness. After about 300 minutes (30 samples) silica was detected in the effluent. The capacity of the alumina was determined to be 30 mg for this experiment or 15 mg/g alumina.

The GRC alumina was tested under similar conditions. Breakthrough occurred at approximately 1130 minutes corresponding to 114 mg of silica or 57 mg silica/g alumina. The GRC material had more than three times the capacity of the commercial basic alumina.

The regenerated GRC-MPA demonstrated 61.0% silica removal in a small-scale bottle test as compared to unregenerated, silica loaded GRC-MPA, which demonstrated 18.2% removal in a bottle test. The same amount of fresh GRC-MPA achieved approximately 71.3% removal.

### Example 6

### Bottle Testing for Silica Removal

Mesoporous aluminas containing 5% molybdenum prepared according to Example 6 were tested against GRC-MPA without molydebnum in bottle tests. The samples containing molybdenum outperformed those without. Results are shown in Table 7.

TABLE 7

| | g | mL Si | g | % |
|---|---|---|---|---|
| Material | sorbent | water | sorbent/mL | Removal |
| GRC MPA | 0.127 | 125 | 0.001016 | 27.90% |
| GRC MPA | 0.2638 | 125 | 0.0021104 | 50.65% |
| GRC MPA | 0.3796 | 125 | 0.0030368 | 64.56% |
| GRC MPA | 0.36 | 45 | 0.008 | 96.10% |
| GRC MPA | 0.72 | 45 | 0.016 | 98.40% |
| GRC MPA (Mo-acac) | 0.1303 | 125 | 0.0010424 | 35.92% |
| GRC MPA (Mo-acac) | 0.2575 | 125 | 0.00206 | 63.67% |
| GRC MPA (Mo-acac) | 0.3776 | 125 | 0.0030208 | 76.62% |
| GRC MPA (Mo-acac) | 0.1024 | 20 | 0.00512 | 97.08% |
| GRC MPA (Mo-acac) | 0.241 | 20 | 0.01205 | 100.00% |
| GRC MPA (Mo-acac) | 0.1709 | 20 | 0.008545 | 100.00% |
| GRC MPA (Mo-acac) | 0.341 | 20 | 0.01705 | 100.00% |
| GRC MPA (Ammonium | 0.1283 | 125 | 0.0010264 | 48.60% |
| Molybdate) | | | | |
| GRC MPA (Ammonium | 0.2533 | 125 | 0.0020264 | 76.61% |
| Molybdate) | | | | |
| GRC MPA (Ammonium | 0.3752 | 125 | 0.0030016 | 89.79% |
| Molybdate) | | | | |
| GRC MPA (Ammonium | 0.0939 | 20 | 0.004695 | 98.36% |
| Molybdate) | | | | |
| GRC MPA (Ammonium | 0.16 | 20 | 0.008 | 100.00% |
| Molybdate) | | | | |
| GRC MPA (Ammonium | 0.2473 | 20 | 0.012365 | 100.00% |
| Molybdate) | | | | |
| GRC MPA (Ammonium | 0.3204 | 20 | 0.01602 | 100.00% |
| Molybdate) | | | | |

### Example 7

### Capacity Tests on Molybdenum Templated Alumina

Capacity tests (30-minute) were performed on the molybdenum templated aluminas. The calculated capacity of these materials as compared to the other materials previously tested are shown in Table 8. While the regular GRC alumina has a capacity that is 2.4 times that of basic activated alumina, the molybdenum templated alumina that was prepared using ammonium molybdate has a capacity that is 7.0 times that of basic activated alumina, and 2.9 times that of the regular GRC alumina.

TABLE 8

| Material | Capacity (mg/g) |
|---|---|
| Sigma Basic Activated Alumina | 7.64 |
| Sigma Neutral Activated Alumina | 8.20 |
| GRC MPA | 18.61 |
| Mo templated alumina (Mo-acac) | 34.22 |
| Mo templated alumina (Ammonium | 53.28 |
| molybdate) | |

While only certain features and embodiments have been illustrated and described herein, many modifications and changes may occur to one of ordinary skill in the relevant art. The appended claims cover all such modifications and changes.

1. A water treatment method for reducing silica concentration in water containing at least 100 ppm dissolved or suspended silica, said method comprising
contacting the water with particles comprising mesoporous alumina having BET surface area ranging from about 250 m²/g to about 600 m²/g and pore volume ranging from about 0.1 cm³/g to about 1.0 cm³/g; and
separating the treated water from the particles.

2. A water treatment method according to claim 1, wherein concentration of silica in the water is reduced to less than about 10 ppm.

3. A water treatment method according to claim 1, wherein pH of the water ranges from about 5 to about 8.

4. A water treatment method according to claim 1, wherein the water is contacted with the particles at a temperature ranging from about 5° C. to about 100° C.

5. A water treatment method according to claim 1, wherein the water is passed through a column containing the particles.

6. A water treatment method according to claim 1, wherein the water additionally comprises calcium ions, magnesium ions or a combination thereof.

7. A water treatment method according to claim 1, additionally comprising regenerating the particles after separating the treated water.

8. A water treatment method according to claim 1, wherein surface area of the mesoporous alumina ranges from about 300 m²/g to about 450 m²/g.

9. A water treatment method according to claim 1, wherein pore volume of the mesoporous alumina ranges from about 0.25 cm³/g to about 1.0 cm³/g.

10. A water treatment method according to claim 1, wherein pore volume of the mesoporous alumina ranges from about 0.4 cm³/g to about 0.9 cm³/g.

11. A water treatment method according to claim 1, wherein the mesoporous alumina is prepared by reacting an aluminum alkoxide in the presence of a polyethylene glycol phenyl ether templating agent.

12. A water treatment method according to claim 10, wherein polyethylene glycol phenyl ether templating agent is polyethylene glycol tert-octylphenyl ether.

13. A water treatment method according to claim 10, additionally comprising reacting the aluminum alkoxide in the presence of ethyl acetoacetonate and the polyethylene glycol tert-octylphenyl ether templating agent.

14. A water treatment method according to claim 10, wherein the aluminum alkoxide is aluminum sec-butoxide.

15. A water treatment method according to claim 1, wherein the mesoporous alumina comprises molybdenum.

16. A water treatment method according to claim 14, wherein the molybdenum is present in an amount ranging from about 0.05 weight percent to about 10 weight percent based on total weight of the mesoporous alumina.

17. A water treatment method according to claim 1, wherein the amount of molydenum ranges from about 0.1 weight percent to about 5 weight percent based on total weight of the mesoporous alumina.

18. A water treatment method according to claim 1, wherein the amount of molydenum ranges from about 0.1 weight percent to about 2 weight percent based on total weight of the mesoporous alumina.

19. A water treatment method according to claim 1, wherein the amount of molydenum ranges from about 0.05 weight percent to about 1 weight percent based on total weight of the mesoporous alumina.

20. A water treatment method according to claim 1, additionally comprising subjecting the water to electro-dialysis reversal.

21. A water treatment method for reducing silica concentration in water containing at least 100 ppm dissolved or suspended silica, said method comprising
contacting the water with mesoporous alumina particles comprising molybdenum; and
separating the treated water from the particles.

22. A water treatment method according to claim 21, wherein the molybdenum is present in an amount ranging from about 0.05 weight percent to about 10 weight percent based on total weight of the mesoporous alumina.

23. A water treatment method according to claim 21, wherein the amount of molydenum ranges from about 0.1 weight percent to about 5 weight percent based on total weight of the mesoporous alumina.

24. A water treatment method according to claim 21, wherein the amount of molydenum ranges from about 0.1 weight percent to about 2 weight percent based on total weight of the mesoporous alumina.

25. A water treatment method according to claim 21, wherein the amount of molydenum ranges from about 0.05 weight percent to about 1 weight percent based on total weight of the mesoporous alumina.
